(19) United States
(12) Patent Application Publication
(10) Pub. No.: US 2010/0003578 A1
(43) Pub. Date: Jan. 7, 2010

(54) ENERGY CONVERTER AND/OR ENERGY STORAGE DEVICE WITH FLUORINE-ABSORBING CASING

(76) Inventors: Thomas Wahl, Pforzheim (DE); Ulrich Sauter, Karlsruhe (DE); Florian Wahl, Lohr (DE); Leonore Schwegler, Stuttgart (DE); Bernd Schumann, Rutesheim (DE); Niluefer Baba, Stuttgart (DE); Martin Holger Koenigsmann, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/463,810

(22) Filed: May 11, 2009

(30) Foreign Application Priority Data
May 9, 2008 (DE) 10 2008 001 707.8

(51) Int. Cl. H01M 2/02

(52) U.S. Cl. 429/34

(57) ABSTRACT

The present invention relates to a energy converter ad/or energy storage device, including one or more energy converter and/or energy storage units, such as fuel cells and/or battery units. The energy converter and/or energy storage units according to the invention are surrounded by a casing which has at least one fluorine absorber, in particular a hydrogen fluoride absorber, selected from the group including carbonates, hydroxides, oxides, chlorides, bromides, iodides, sulfates, and/or phosphates of alkali metals, alkaline earth metals, lanthanoides, and/or silicon.

### CROSS-REFERENCE TO RELATED APPLICATION

This application is based on German Patent Application 10 2008 001 707.8 filed May 9, 2008.

### BACKGROUND OF THE INVENTION

1. Field of the Invention

The present invention relates to an energy converter- and/or energy storage device, including one or more energy converter and/or energy storage units, such as fuel cells and/or battery units.

2. Description of the Prior Art

In modern fuel cells, membranes are used that contain fluorinated polymers, such as Nafion™ and the like. In membranes that at present are not used in fluorinated form as well, there is some discussion of achieving greater stability by fluorinating the side chains thereof.

In rechargeable batteries, in particular lithium ion batteries, electrolytes containing fluorine are also often used.

Upon bag (destruction) or overheating of a fuel cell or a rechargeable battery, the fluorine-containing membrane or the fluorine-containing electrolytes produce toxic and volatile fluorine-containing compounds such as hydrogen fluoride (so-called “hydrofuoric acid”, HF). These toxic and volatile fluorine-containing compounds may escape from conventional fuel cells and rechargeable batteries and are a risk to the users health and the environment.

### OBJECT AND SUMMARY OF THE INVENTION

The energy converter and/or energy storage device according to the invention has the advantage that n a fire or on overheating of an energy converter and/or energy storage unit, such as a fuel cell and/or a battery unit, the emission of toxic and volatile fluorine-containing compounds such as hydrogen fluoride can be reduced or even averted by the use according to the invention of fluorine absorbers in the casing. Thus by means of the casing according to the invention that includes fluorine absorbers, the present invention makes a passive safety element available for energy converter and/or energy storage unit or units, such as fuel cells and battery units.

### BRIEF DESCRIPTION OF THE DRAWINGS

The invention will be better understood and further objects and advantages thereof will become more apparent from the ensuing detailed description of preferred embodiments taken in conjunction with the drawings, in which.

FIG. 1 is a schematic cross section through a first embodiment of a energy converter and/or energy storage device according to the invention;

FIG. 2 is a schematic cross section through a second embodiment of an energy converter and/or energy storage device according to the invention;

FIG. 3 is a schematic cross section through a third embodiment of an energy converter and/or energy storage device according to the invention;

FIG. 4 is a schematic cross section through a fourth-embodiment of an energy converter and/or energy storage device according to the invention; and

FIG. 5 is a schematic cross section through a fifth embodiment of an energy converter and/or energy storage device according to the invention.

### DESCRIPTION OF THE PREFERRED EMBODIMENTS

Below, advantageous embodiments of the invention will be described in terms of examples.

The subject of the present invention is an energy converter and/or energy storage device which includes one or more energy converter and/or energy storage unit or units.

The term energy converter device is understood in the sense of the present invention to mean a device which is suitable for converting one kind of energy, such as chemical energy, into another kind of energy, such as electrical energy. This applies for instance to devices that include a fuel cell, an internal combustion engine, and/or a rechargeable battery unit. Devices including a battery unit are furthermore suitable for storing energy and can therefore be called energy storage devices, energy converter devices, or energy converter and energy storage devices. For instance, an energy converter and/or energy storage device within the scope of the present invention includes and in particular is based on a fuel cell and/or battery device.

Accordingly, the energy converter and/or energy storage unit or units within the scope of the present invention can be selected from the group including fuel cells and/or battery units and/or internal combustion engines. In particular, the energy converter and/or energy storage unit or units within the scope of the present invention can be selected from the group including fuel cells and/or battery units.

For example, the energy converter and/or energy storage device may include a plurality of identical energy converter and/or energy storage units, for instance a plurality of fuel cells (so-called fuel cell stacks) or a plurality of battery units (so-called battery packs). Within the scope of the present invention, however, it is equally possible for the energy converter and/or energy storage device to include a hybrid system comprising different energy converter and/or energy storage unit or units, such as one or more fuel cells and one or more battery units, or one or more fuel cells and an internal combustion engine.

The energy converter and/or energy storage unit or units within the scope of the present invention are surrounded by a casing which includes at least one wall of a substrate material. According to the invention, the casing has at least one fluorine absorber, in particular a hydrogen fluoride absorber. This absorber is selected according to the invention from the group including carbonates, hydroxides, oxides, chlorides, bromides, iodides, sulfates, and/or phosphates of alkali metals, alkaline earth metals, lanthanoides, and/or silicon. The fluorine absorber or fluorine absorbers are disposed according to the invention on the inside and/or the outside of the first wall and/or incorporated in the substrate material of the first wall.

The term “inside” of a wall is understood in the sense of the present invention to mean that side of the wall which faces toward the energy converter and/or energy storage unit or units, such as fuel cells and/or battery units. Accordingly, within the scope of the present invention, the term “outside” of a wall will be understood to mean that side of the wall which faces away from the energy converter and/or energy storage unit or units, such as fuel cells and/or battery units.

The fluorine absorbers according to the invention perform their function by binding fluorine-containing compounds, such as hydrogen fluoride (hydrofluoric acid, HF), forming preferably nonvolatile and harmless substances. For example, a fluorine absorber according to the invention can bind hydrogen fluoride, forming a poorly soluble salt, in accordance with one of the following reaction equations:

CaCl₂+2HF→CaF₂+2HCl ΔG^{o}_{R}=−74.8 kJ/mol

ΔH^{o}_{R}=−66.6 kJ/mol

Na₂CO₃+2HF→2NaF+CO₂+H₂O ΔG^{o}_{R}=−124.4 kJ/mol

ΔH^{o}_{R}=−154.3 kJ/mol

Mg(OH)₂+2HF→MgF₂+2H₂O ΔG^{o}_{R}=−162.44 kJ/mol

ΔH^{o}_{R}=−207.06 kJ/mol

Ca(OH)₂+2HF→CaF₂+2H₂O ΔG^{o}_{R}=−200.06 kJ/mol

ΔH^{o}_{R}=−266.31 kJ/mol

CaCO₃+2HF→CaF₂+CO₂+H₂O ΔG^{o}_{R}=−422.3 kJ/mol

ΔH^{o}_{R}=−155.3 kJ/mol

The negative values for the Gibbs energy ΔG^{o}_{R} show that the reactions are subject to a strong propulsive force and proceeds spontaneously and independently.

The Gibbs energy of the reaction of carbonates, in particular calcium carbonate and magnesium carbonate, with hydrogen fluoride is especially high, since salts, in particular calcium fluoride and magnesium fluoride, respectively, that are practically insoluble in most solvents, such as water, dilute acids and alcohols, are formed, but also the reaction is additionally advantageously affected by the fact that gaseous carbon dioxide is extracted from the reaction equilibrium.

The formation of carbon dioxide furthermore has the advantage that the progress of the reaction on “burnout” of an energy converter and/or energy storage it, such as a fuel cell or a lithium ion batter can be impeded because the resultant carbon dioxide prevents oxygen from the air from further reacting with components, such as the metal and in particular lithium, of the battery.

For instance, according to the invention, the casing therefore has at least one fluorine absorber, selected from the group including calcium carbonate, calcium hydroxide, calcium oxide, calcium chloride, calcium sulfate, calcium phosphate, hydroxyl apatite, magnesium carbonate, magnesium hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate.

Since the reactions leading to calcium fluoride and magnesium fluoride are subject to an especially high propulsive force, and both calcium fluoride and magnesium fluoride are chemically highly stable (melting point (CaF₂: 1418° C.), boiling point (CaF₂: 2513° C.); melting point (MgF₂: 1266° C.), boiling point (MgF₂: 2260° C.)) and are nontoxic to human beings, the fluorine absorbers reacting with them are preferred within the scope of the present invention.

Preferably, the casing of the invention therefore has at least one fluorine absorber, selected from the group including calcium carbonate, calcium hydroxide, calcium oxide, magnesium carbonate, magnesium hydroxide, magnesium oxide, sodium carbonate, sodium hydrogen carbonate, sodium hydroxide, and sodium oxide.

Furthermore, since the use of calcium carbonate and/or magnesium carbonate as fluorine absorbers—as already explained—impedes the progress of the reaction upon “burnout” of an energy converter and/or energy storage unit, such as a fuel cell or battery, the casing of the invention especially preferably has calcium carbonate and/or magnesium carbonate.

The additional use of a base has proved advantageous, especially in the use of fluorine absorbers whose reaction with hydrogen fluoride produces a different acid from hydrofluoric acid is produced, such as calcium chloride, calcium sulfate, calcium phosphate, magnesium chloride, magnesium sulfate, magnesium phosphate, sodium chloride, sodium sulfate, and/or sodium phosphate, since the base neutralizes the resultant acid and thus advantageously both prevents the volatilization of etching acids, such as hydrochloric acid (HCl) and also advantageously shifts the reaction equilibrium.

For instance, the following reaction:

CaCl₂+2HF→CaF₂+2HCl ΔG^{o}_{R}=−74.8 kJ/mol

ΔH^{o}_{R}=−66.6 kJ/mol

which while it proceeds independently nevertheless has a higher Gibbs energy ΔG^{S}_{R} and activation energy ΔH^{o}_{R} for instance as the reaction of calcium carbonate and hydrogen fluoride (ΔG^{S}_{R}|=−422.3 kJ/mol, ΔH^{o}_{R}=−155.3 kJ/mol), can advantageously be affected by an ensuing neutralization reaction:

2HCl+2KOH→2KCl+2H₂O ΔG^{o}_{R}=−343.48 kJ/mol

ΔH^{o}_{R}=−411.04 kJ/mol

so that overall, a Gibbs energy ΔG^{o}_{R} of −418.28 kJ/mol and an activation energy ΔH^{o}_{R} of −477.64 kJ/mol can ensue.

Within the scope of one embodiment of the invention, the casing of the invention therefore further has at least one base, such as alkali and/or alkaline earth metal hydroxides or ammonia, in particular sodium hydroxide and/or potassium hydroxide. Preferably, the base is distributed homogeneously in the fluorine absorber or fluorine absorbers.

FIG. 1 shows a schematic cross section though a first embodiment 21 of an energy converter and/or energy storage device of the invention. The first embodiment 21, like the embodiments 22, 23, 24, 25 described below, includes a plurality of energy converter and/or energy storage units 1, such as one or more fuel cells and/or one or more battery units, and the energy converter and/or energy storage units 1 are surrounded by a casing 2 of a substrate material. According to the invention, the casing 2 according to the invention has at least one fluorine absorber 4, in particular a hydrogen fluoride absorber, selected from the group including carbonates, hydroxides, oxides, chlorides, bromides, iodides, sulfates, and/or phosphates of alkali metals, alkaline earth metals, lanthanoides, and/or silicon.

Within the scope of the present invention, fundamentally all the fluorine absorbers according to the invention can be used in the form of a solid. For instance, carbonates, hydroxides, oxides, and/or silicates of alkali metals and/or alkaline earth metals, in particular carbonates and/or silicates of sodium, of magnesium, and/or of calcium, as well as silicon dioxide can be used as the solid within the scope of the present invention.

For instance, in the case of calcium chloride, whose lattice energy at −324 kJ/mol is relatively high, the use in the form of a solution with in the scope of the present invention has proved to be advantageous, since as a result, the lattice energy, which in the ease of a solid must be expended in addition to the actual activation energy, is eliminated. Salts of calcium and/or of magnesium, especially magnesium chloride and/or calcium chloride, are therefore advantageously used as solutions, in particular aqueous solutions, within the scope of this inventive embodiment. The use of solutions within the scope of the present invention has proved especially advantageous, since some fluorine compounds can dissolved in the solution and can furthermore, such as carbonyl fluoride (COF₂) in aqueous solution, can break down into compounds such as CO₂ and HF, which in turn can be bound by simple fluorine absorbers in the solution, such as magnesium chloride and/or calcium chloride.

Besides being in the form of undissolved solid or an in particular aqueous solution, fluorine absorbers within the scope of the present invention may also be incorporated in an unfluorinated, in particular unhalogenated, polymer or in a mixture of a plurality of unfluorinated, in particular unhalogenated, polymers, such as polyurethane and/or polystyrene, or in a porous insulating material, such as mineral wool, in particular glass wool or rock wool, a polyurethane foam, or a polystyrene foam. Preferably, the fluorine absorbers are incorporated in a homogeneously distributed manner. The proportion of fluorine absorbers incorporated in a polymer or in a mixture of a plurality of polymers or in a porous insulating material may according to the invention be in a range from ≧1 wt-% to ≦80 wt-%, for instance from ≧3 wt-% to ≦60 wt-%, and in particular from ≧5 wt-% to ≦40 wt-%, referred to the total weight of the polymer or the insulating material.

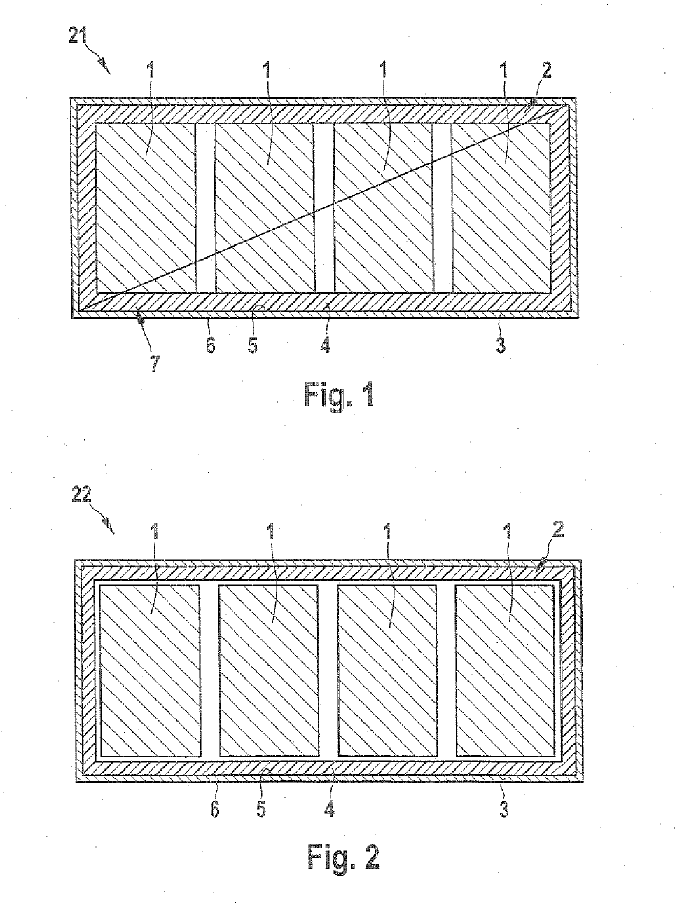

Within the scope of the first embodiment 21 shown in FIG. 1—as well as the embodiments 22; 23; 25 shown in FIGS. 2, 3 and 5—the casing 2 includes a first wall 3.

FIG. 1 shows that the fluorine absorber or fluorine absorbers 4 are disposed on the inside 5 of the first wall 3. However, within the scope of the present invention, it is equally possible for the fluorine absorber 4 to be disposed only on the outside 6, or on both the inside 5 and the outside 6, of the first wall 3 or a further wall.

As FIG. 1 shows, within the scope of the first embodiment 21 of the invention, the fluorine absorber 4 is disposed on the inside 5 of the first wall 3 in such a way that an interstice 7 between the inside 5 of the first wall 3 and the energy converter and/or energy storage unit or units, such as fuel cell or cells and/or battery unit or units, is filled partially or completely with the fluorine absorber 4.

FIG. 2 shows a schematic cross section through a second embodiment 22 of an energy converter and/or energy storage device of the invention. Within the scope of this embodiment as well, the fluorine absorber 4 is disposed on the inside 5 of the first wall 3. However, the second embodiment 22 shown in FIG. 2 differs from the first embodiment 21 shown in FIG. 1 in that the first wall 3 is coated with a fluorine absorber 4 or with a mixture of a plurality of fluorine absorbers 4. Preferably, within the scope of the present invention, the inside 5 of the first wall 3 is coated with fluorine absorbers 4. However, it is equally possible within the scope of the present invention for only the outside 6 or for both the inside 5 and the outside 6 of the first wall 3 or a further wall to be coated with fluorine absorbers 4.

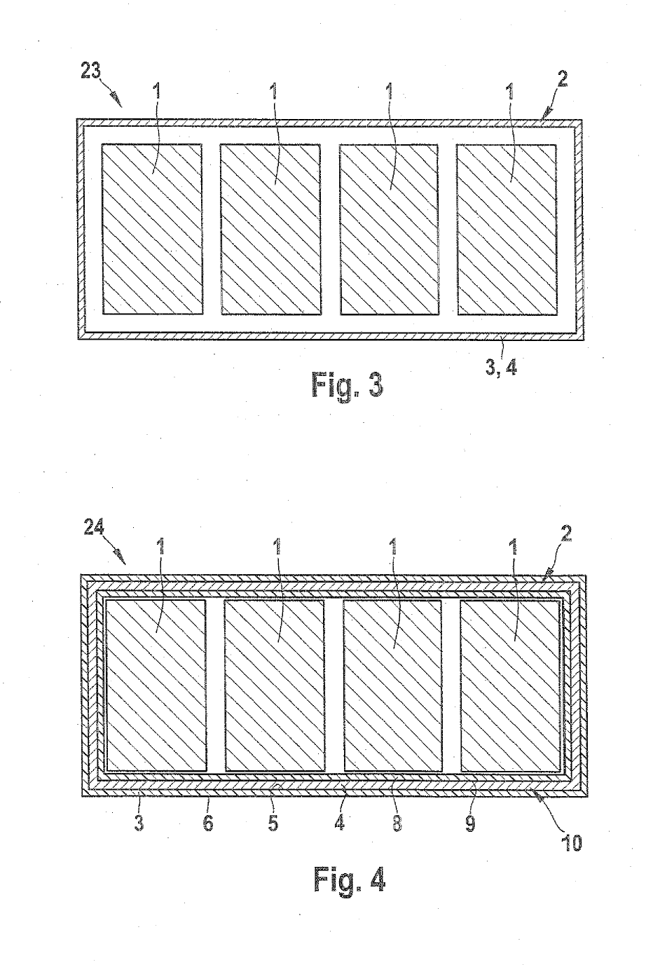

FIG. 3 shows a schematic cross section through a third embodiment 23 of an energy converter and/or energy storage device of the invention. Within the scope of the third embodiment 23, the fluorine absorber 4 is incorporated in the substrate material of the first wall 3. However, within the scope of the present invention, it is equally possible to incorporate the fluorine absorber 4 in the substrate material of a different wall or of a plurality of walls, such as a second wall, of the casing 2 of the invention. Preferably, the fluorine absorber is distributed/incorporated homogeneously in the substrate material. For that purpose, the substrate material of one or more walls, in particular of the first wall 3 and/or of a second wall 8 shown in FIG. 4, can for instance be a conventional fireproofing agent, in particular an fluorinated, in particular unhalogenated, polymer or a mixture of a plurality of unfluorinated, in particular unhalogenated, polymers, such as polyurethane and/or polystyrene, or a porous insulating material, such as mineral wool, in particular glass wool and/or rock wool, a polyurethane foam or a polystyrene foam, in which the fluorine absorbers are incorporated, which particularly at the burning/overheating temperature of an energy converter and/or energy storage unit 1, such as a fuel cell or battery unit, releases only little, and preferably no, fluorine-containing and in particular halogen-containing compounds. Within the scope of other embodiments, such as the first, second, fourth and fifth embodiments of the invention, however, the substrate material may also be a different material, such as a ceramic, a metal, or a metal alloy, which in particular at the burning/overheating temperature of an energy converter and/or energy storage unit 1 releases only little, and preferably no, fluorine-containing, in particular halogen-containing, compounds.

Incorporating the fluorine absorber in an unfluorinated, in particular unhalogenated polymer or in a mixture of a plurality of unfluorinated, in particular unhalogenated polymers, can be attained for instance by adding the fluorine absorber to the unfluorinated, in particular unhalogenated, polymer or to the mixture of a plurality of unfluorinated, in particular unhalogenated polymers, in the polymerization. Preferably, a calcium and/or magnesium salt is used, in particular calcium carbonate, calcium hydroxide, calcium oxide, hydroxyl apatite, magnesium carbonate, magnesium hydroxide, and/or magnesium oxide, is used as the fluorine absorber.

FIG. 4 shows a schematic cross section through a fourth embodiment 24 of an energy converter and/or energy storage device of the invention. Within the scope of the fourth embodiment 24, the casing 2 of the invention has a second wall 8 of a substrate material. The second wall 8 is disposed in such a way to the first wall 3 that an interstice 10 is embodied between the first wall 3 and second wall 8, in particular between the inside 5 of the first wall 3 and the outside 9 of the second wall 8. As FIG. 4 shows, the energy converter and/or energy storage unit or units 1, for instance fuel cells and/or battery units, are disposed inside both the first wall 3 and the second wall 8 of the casing 2. At least one fluorine absorber 4, for instance as an in particular aqueous fluorine absorber solution, is disposed in the interstice 10 between the first wall 3 and the second wall 8. The fluorine absorber can for instance fill the interstice between the first wall 3 and the second wall 8 partially or completely.

Within the scope of the present invention, it is furthermore possible for the casing 2 to have still further walls. For instance, the casing may include two or more walls which partially or completely surround the energy converter and/or energy storage unit or units 1, for instance fuel cell or cells and/or battery unit or units, for instance in shell-like or onion-like form. The individual walls can be disposed relative to one another in such a way that between some walls there is an interstice, while other walls adjoin one another without forming an interstice. At least one fluorine absorber 4 can be disposed in an at least one interstice between two walls, for instance in the interstice between the first wall 3 and the second wall 8, or in at least two interstices between a plurality of walls. This kind of shell-like or onion-like casing has the advantage that for enhancing safety, different fluorine absorbers, different concentrations of fluorine absorbers, and/or different forms of fluorine absorbers, for instance as a solid, solution or incorporating, can be placed between the various shells of the casing.

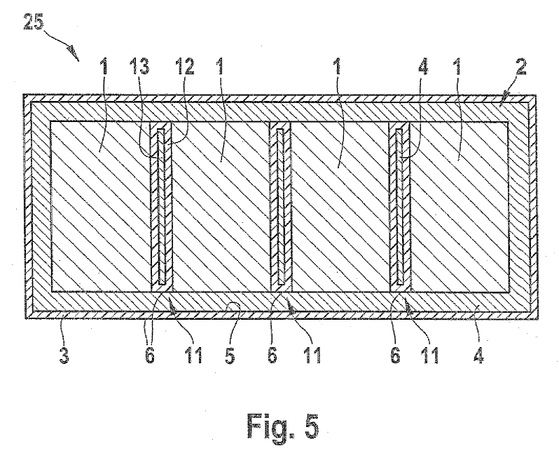

FIG. 5 shows a schematic cross section tough a fifth embodiment 25 of al energy converter and/or energy storage device of the invention. Within the scope of the fifth embodiment 25, a plurality of capsules 11 are integrated with the energy converter and/or energy storage device. For instance, the capsule or capsules 11 can be disposed between the energy converter and/or energy storage unit or units 1, such as fuel cells and/or battery units, and/or in the energy converter and/or energy storage unit or units 1. According to the invention, the capsules 11 include a capsule wall 12 and at least one fluorine absorber 4. The capsule wall 12 is embodied such that there is a capsule inner chamber 13 inside which the fluorine absorber 4 is disposed. According to the invention, the capsule wall 12 is preferably embodied of a material which becomes gas-permeable and/or melts at a temperature, for example ≧180° C., in particular ≧130° C., that corresponds to the burning/overheating temperature of an energy converter and/or energy storage unit 1, such as a fuel cell or a battery unit. It should be noted that for instance in high-temperature batteries, the capsule wall 12 can according to the invention be embodied from a material which becomes gas-permeable and/or melts at higher temperatures than those given above. For instance, the fluorine absorber 4 can be selected from the group including carbonates, hydroxides, oxides, chlorides, bromides, iodides, sulfates, and/or phosphates of alkali metals, alkaline earth metals, lanthanoides, and/or silicon, selected for instance from the group including calcium carbonate, calcium hydroxide, calcium oxide, calcium chloride, calcium sulfate, calcium phosphate, hydroxyl apatite, magnesium carbonate, magnesium hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate, preferably selected from the group including calcium carbonate, calcium hydroxide, calcium oxide, magnesium carbonate, magnesium hydroxide, magnesium oxide, sodium carbonate, sodium hydrogen carbonate, sodium hydroxide, and sodium oxide, especially preferably calcium carbonate and/or magnesium carbonate.

Within the scope of a further embodiment, not shown of the present invention, the casing 2, in particular the outermost wall of the casing 2, has a window of silicate glass for the optical detection of an emergence of flourine compounds, in particular hydrogen fluoride, from the energy converter and/or energy storage it or units 1, such as the fuel cell or cells and/or battery unit or units. Silicate glass means that the glass includes SiO₄ tetrahedrons. Advantageously, by the use of such a window, the emergence of fluorine compounds, especially hydrogen fluoride, can be detected by clouding of the glass. The use of a window of silicate glass is important, especially in the case where so-called “hot spots” develop in the fluorine-containing membrane or in the fluorine-containing electrolyte of an energy converter and/or energy storage unit, such as a fuel cell or an accumulator unit, in which hydrogen fluoride emerges locally.

Within the scope of a further embodiment of the present invention, not shown, at least one component of an energy converter and/or energy storage unit 1, such as a fuel cell or battery unit, and/or at least one region of an energy converter and/or energy storage unit 1, such as a fuel cell 1 or battery 1, includes at least one fluorine absorber 4, selected from the group including carbonates, hydroxides, oxides, chlorides, bromides, iodides, sulfates, and/or phosphates of alkali metals, alkaline earth metals, lanthanoides, and/or silicon, selected for instance from the group including calcium carbonate, calcium hydroxide, calcium oxide, calcium chloride, calcium sulfate, calcium phosphate, hydroxyl apatite, magnesium carbonate, magnesium h-hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate, preferably selected from the group including calcium carbonate, calcium hydroxide, calcium oxide, magnesium carbonate, magnesium h-hydroxide, magnesium oxide, sodium carbonate, sodium hydrogen carbonate, sodium hydroxide, and sodium oxide, especially preferably calcium carbonate and/or magnesium carbonate. For instance, at least one component of an energy converter and/or energy storage unit 1 and/or at least one region of an energy converter and/or energy storage unit 1 may be coated and/or lined with at least one fluorine absorber 4 within the scope of this embodiment.

The foregoing relates to preferred exemplary embodiments of the invention, it being understood that other variants and embodiments thereof are possible within the spirit and scope of the invention, the latter being defiled by the appended claims.

1. An energy converter and/or energy storage device, comprising:
one or more energy converter and/or energy storage units; and
a casing surrounding the energy converter and/or energy storage unit or units, the casing including at least one first wall of a substrate material and the easing having at least one fluorine absorber, in particular a hydrogen fluoride absorber, selected from the group including carbonates, hydroxides, oxides, chlorides, bromides, iodides, sulfates, and/or phosphates of alkali metals, alkaline earth metals, lanthanoides, and/or silicon,
wherein the fluorine absorber or fluorine absorbers are disposed on an inside and/or an outside of the first wall, and/or are incorporated in the substrate material of the first wall.

2. The energy converter and/or energy storage device as defined by claim 1, wherein the energy converter and/or energy storage unit or units are selected from a group including fuel cells and/or battery units.

3. The energy converter and/or energy storage device as defined by claim 1, wherein the casing has at least one fluorine absorber, selected from the group including calcium carbonate, calcium hydroxide, calcium oxide, calcium chloride, calcium sulfate, calcium phosphate, hydroxyl apatite, magnesium carbonate, magnesium hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate.

4. The energy converter and/or energy storage device as defined by claim 2, wherein the casing has at least one fluorine absorber, selected from the group including calcium carbonate, calcium hydroxide, calcium oxide, calcium chloride, calcium sulfate, calcium phosphate, hydroxyl apatite, magnesium carbonate, magnesium hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate.

5. The energy converter and/or energy storage device as defined by claim 1, wherein the casing has at least one fluorine absorber, selected from the group including calcium carbonate, calcium hydroxide, calcium oxide, magnesium carbonate, magnesium hydroxide, magnesium oxide, sodium carbonate, sodium hydrogen carbonate, sodium hydroxide, and sodium oxide.

6. The energy converter and/or energy storage device as defined by claim 2, wherein the casing has at least one fluorine absorber, selected from the group including calcium carbonate, calcium hydroxide, calcium oxide, magnesium carbonate, magnesium hydroxide, magnesium oxide, sodium carbonate, sodium hydrogen carbonate, sodium hydroxide, and sodium oxide.

7. The energy converter and/or energy storage device as defined by claim 1, wherein the casing has calcium carbonate and/or magnesium carbonate as the fluorine absorber.

8. The energy converter and/or energy storage device as defined by claim 2, wherein the casing has calcium carbonate and/or magnesium carbonate as the fluorine absorber.

9. The energy converter and/or energy storage device as defined by claim 1, wherein the casing further has at least one base, such as alkali and/or alkaline earth metal hydroxides or ammonia, in particular sodium hydroxide and/or potassium hydroxide.

10. The energy converter and/or energy storage device as defined by claim 2, wherein the casing further has at least one base, such as alkali and/or alkaline earth metal hydroxides or ammonia, in particular sodium hydroxide and/or potassium hydroxide.

11. The energy converter and/or energy storage device as defined by claim 1, wherein the first wall is coated with a fluorine absorber or a mixture of a plurality of fluorine absorbers.

12. The energy converter and/or energy storage device as defined by claim 2, wherein the first wall is coated with a fluorine absorber or a mixture of a plurality of fluorine absorbers.

13. The energy converter and/or energy storage device as defined by claim 1, wherein the casing further has a second wall of a substrate material, the second wall being disposed relative to the first wail such that between the first wall and second wall, and in particular between the inside of the first wall and an outside of the second wall, an interstice is embodied, and at least one fluorine absorber is disposed in the interstice.

14. The energy converter and/or energy storage device as defined by claim 1, wherein the fluorine absorber or fluorine absorbers are in the form of
an undissolved solid, or
a solution, in particular an aqueous solution, or
are incorporated in an fluorinated polymer or in a mixture of a plurality of unfluorinated polymers, such as polyurethane and/or polystyrene, or in a porous insulating material, such as mineral wool, a polyurethane foam, or a polystyrene foam.

15. The energy converter and/or energy storage device as defined by claim 1, wherein the proportion of fluorine absorbers incorporated in a polymer or in a mixture of a plurality of polymers or in a porous insulating material is in a range from ≧1 wt-% to ≦80 wt-%, for instance from ≧3 wt-% to ≦60 wt-%, and in particular from ≧5 wt-% to ≦40 wt-%, referred to the total weight of the polymer or the insulating material.

16. The energy converter and/or energy storage device as defined by claim 1, wherein the substrate material of one or more walls in particular of the first wall and/or second wall, is an unfluorinated polymer or a mixture of a plurality of unfluorinated polymers, such as polyurethane and/or polystyrene, or a porous insulating material, such as mineral wool, a polyurethane foam or polystyrene foam, in which the fluorine absorber or fluorine absorbers are incorporated.

17. The energy converter and/or energy storage device as defined by claim 1, wherein the casing, and in particular the outermost wall of the casing, has a window of silicate glass for the optical detection of an emergence of fluorine compounds, in particular hydrogen fluoride, from the energy converter and/or energy storage unit or units.

18. The energy converter and/or energy storage device as defined by claim 1, wherein one or more capsules are furthermore integrated with the energy converter and/or energy storage device, and a capsule includes a capsule wall and at least one fluorine absorber, selected from die group including carbonates, hydroxides, oxides, chlorides, bromides, iodides, sulfates, and/or phosphates of alkali metals, alkaline earth metals, lanthanoides, and/or silicon, selected for instance from the group including calcium carbonate, calcium hydroxide, calcium oxide, calcium chloride, calcium sulfate, calcium phosphate, hydroxyl apatite, magnesium carbonate, magnesium hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate, preferably selected from the group including calcium carbonate, calcium hydroxide, calcium oxide, magnesium carbonate, magnesium hydroxide, magnesium oxide, sodium carbonate, sodium hydrogen carbonate, sodium hydroxide, and sodium oxide, especially preferably calcium carbonate and/or magnesium carbonate, and the capsule wall is embodied such that a capsule inner chamber is embodied in which the fluorine absorber or fluorine absorbers are disposed.

19. The energy converter and/or energy storage device as defined by claim 1, wherein the capsule wall is embodied of a material which becomes gas-permeable and/or melts at a temperature which corresponds to the burning/overheating temperature of an energy converter and/or energy storage unit, for instance of ≧180° C., and in particular of ≧130° C.

20. The energy converter and/or energy storage device as defined by claim 1, wherein at least one component of an energy converter and/or energy storage unit and/or at least one region of an energy converter and/or energy storage unit includes at least one fluorine absorber, selected from the group including carbonates, hydroxides, oxides, chlorides, bromides, iodides, sulfates, and/or phosphates of alkali metals, alkaline earth metals, lanthanoides, and/or silicon, selected for instance from the group including calcium carbonate, calcium hydroxide, calcium oxide, calcium chloride, calcium sulfate, calcium phosphate, hydroxyl apatite, magnesium carbonate, magnesium hydroxide, magnesium oxide, magnesium chloride, magnesium sulfate, magnesium phosphate, sodium carbonate, sodium hydrogen carbonate, sodium hydroxide, sodium oxide, sodium chloride, sodium sulfate, and sodium phosphate, preferably selected from the group including calcium carbonate, calcium hydroxide, calcium oxide, magnesium carbonate, magnesium hydroxide, magnesium oxide, sodium carbonate, sodium hydrogen carbonate, sodium hydroxide, and sodium oxide, especially preferably calcium carbonate and/or magnesium carbonate.
